(19) United States
(12) Patent Application Publication
(10) Pub. No.: US 2012/0227598 A1
(43) Pub. Date: Sep. 13, 2012

(54) PLATE CYLINDER, PRINTING DEVICE AND PRINTING METHOD

(75) Inventor: Yoshihisa Miura, Miyagi (JP)

(73) Assignee: SONY CORPORATION, Tokyo (JP)

(21) Appl. No.: 13/397,761

(22) Filed: Feb. 16, 2012

(30) Foreign Application Priority Data
Mar. 8, 2011 (JP) 2011-050036

(51) Int. Cl. B41F 9/08; B41F 13/11; B41M 1/12

(52) U.S. Cl. 101/154; 101/170; 101/375

(57) ABSTRACT

A plate cylinder includes a base body with a cylindrical shape which is rotated in a predetermined direction and a pattern plate which is provided on an outer circumference surface of the base body and is rotated integrally with the base body and where a plurality of concave sections, which configures a predetermined printing pattern and is filled with conductive ink, is formed, where a blade, which wipes away the conductive ink which protrudes from the concave sections, contacts the outer circumference surface of the pattern plate, a blanket roll, to which the conductive ink is transferred and which performs printing by transferring the transferred conductive ink to a printing medium, contacts the outer circumference surface of the pattern plate, and a wall, which regulates infiltration of the blade and the blanket roll into the concave sections, is provided in the concave sections.

### CROSS REFERENCES TO RELATED APPLICATIONS

The present application claims priority to Japanese Priority Patent Application JP 2011-050036 filed in the Japan Patent Office on Mar. 8, 2011, the entire content of which is hereby incorporated by reference.

### BACKGROUND

The present disclosure relates to a technical field with regard to a plate cylinder, a printing device, and a printing method. In particular, the present disclosure relates to a technical field of reducing print defects with regard to a printing medium by providing a wall which is formed on a pattern plate and regulates the infiltration of a blade and a blanket roll into a concave section which configures a predetermined printing pattern.

There is a device, where a fine wiring pattern is formed with regard to a flat panel display such as a liquid crystal display (LCD), a plasma display panel (PDP), and an electro luminescence (EL) display.

In such a device, there are an application of a photolithography technique and an etching technique which are semiconductor manufacturing processes, but in order to be provided with a high-level exposure section and to use a vacuum technique, the configuration of device becomes complex.

Here, in recent years, a printing device has been developed which uses a printable electronic technique which forms a fine wiring pattern by printing.

In the printing device which uses the printable electronic technique, there is, for example, a device which performs a gravure offset printing. In such a printing device, printing is performed (for example, refer to Japanese Unexamined Patent Application Publication No. 2010-258381) by a plate cylinder with a cylindrical shape where a predetermined concave pattern is formed on the outer circumference section being rotated and a conductive ink being transferred with regard to a printing medium through a blanket roll which is formed by the outer circumference section having a material such as rubber. In the printing device which uses the printable electronic technique, for example, a wiring pattern with a width of several tens of μm to several μm is printed and formed on the printing medium (glass substrate) using the conductive ink.

### SUMMARY

However, in the printing device described above, the unnecessary conductive ink among the conductive ink which is supplied to the plate cylinder is wiped away by the blade, but there is a concern that the blade infiltrates the predetermined concave pattern which is formed on the plate cylinder and the conductive ink which is filled in the concave pattern may be wiped away by the blade. When wiping away of excessive conductive ink is performed using the blade in this manner, a transfer defect of the conductive ink occurs with regard to the printing medium, and there is a problem in that print defects with regard to the printing medium such as breaking of the wiring pattern are generated.

In addition, in the printing device described above, a blanket roll b comes into contact with regard to a plate cylinder a and conductive ink c is transferred to the blanket roll b, but there is a concern that the outer circumference section of the blanket roll b is elastically deformed due to the contact with the plate cylinder a and the blanket roll b may infiltrate into a concave pattern d which is formed in the plate cylinder a (refer to FIG. 18A). Particularly, when the elastic deformation of the outer circumference section is large, there is a possibility that the blanket roll b may come into contact with the bottom section of the concave pattern d. When infiltration into the concave pattern d is performed due to the elastic deformation of the blanket roll b in this manner, the conductive ink c which is filled into the concave section d is pressed by the blanket roller b (refer to FIG. 18B). For this reason, there is a problem of generation of transfer defects of the conductive ink occurring with regard to the printing medium and generation of print defects with regard to the printing medium such as breaking of the wiring pattern.

Here, it is desirable to provide a plate cylinder, a printing device, and a printing method which overcome the problems described above and reduce printing defects with regard to a printing medium.

According to an embodiment of the present disclosure, there is provided a plate cylinder which is provided with a base body with a cylindrical shape which is rotated in a predetermined direction and a pattern plate which is provided on an outer circumference surface of the base body and is rotated integrally with the base body and where a plurality of concave sections, which configures a predetermined printing pattern and is filled with conductive ink, is formed, where a blade, which wipes away the conductive ink which protrudes from the concave sections, contacts the outer circumference surface of the pattern plate, a blanket roll, to which the conductive ink is transferred and which performs printing by transferring the transferred conductive ink to a printing medium, contacts the outer circumference surface of the pattern plate, and a wall, which regulates infiltration of the blade and the blanket roll into the concave sections, is provided in the concave sections.

Accordingly, in the plate cylinder, the blade contacts the wall when the conductive ink which protrudes from the concave sections of the pattern plate is wiped away using the blade.

In addition, in the plate cylinder, the blanket roll contacts the wall when the conductive ink which is filled into the concave sections is transferred to the blanket roll and a portion of the blanket roll which is pressed against the wall is not elastically deformed in the depth direction of the concave sections.

In the plate cylinder described above, it is desirable that the concave sections be formed as a concave groove section where a portion is a groove shape and the wall extends in the width direction of the concave groove section.

Due to the wall extending in the width direction of the concave groove section, there is a state where the wall extends in a direction which is perpendicular with regard to the extension direction of the concave groove section.

In the plate cylinder described above, it is desirable that the wall extends in a direction which is perpendicular to the rotation axis of the base body.

Due to the wall extending in a direction which is perpendicular to the rotation axis of the base body, the wall moves in a direction which is perpendicular to the rotation axis when the plate cylinder is rotating.

In the plate cylinder described above, it is desirable that a plurality of the walls be provided in the extension direction of the concave groove section.

Due to the plurality of walls being provided in the extension direction of the concave groove section, the wall contacts different portions of each of the blade and the blanket roll when the plate cylinder is rotating.

In the plate cylinder described above, it is desirable that both edges of the wall be each continuous with opening edges of the concave groove section on sides which are opposite in the width direction.

Due to both edges of the wall being continuous with the opening edges of the concave groove section on sides which are opposite in the width direction, when the concave groove section is passed by the front edge of the blade or the blanket roll, the front edge of the blade or the blanket roll is typically in contact with the wall when passing.

In the plate cylinder described above, it is desirable that the wall has a first wall where one edge is continuous with one opening edge of the concave groove section in the width direction and the other edge is separated from the other opening edge of the concave groove section in the width direction, and a second wall where one edge is continuous with the other opening edge of the concave groove section in the width direction and the other edge is separated from the one opening edge of the concave groove section in the width direction.

Due to the wall having the first wall where one edge is continuous with one opening edge and the other edge is separated from the other opening edge and the second wall where one edge is continuous with the other opening edge and the other edge is separated from the one opening edge, there is a state where the first wall and the second wall do not cross the concave groove section.

In the plate cylinder described above, it is desirable that the first wall and the second wall be alternately provided by being separated in the extension direction of the concave groove section.

Due to the first wall and the second wall being alternately provided by being separated in the extension direction of the concave groove section, each portion of the blade in the extension direction of the front edge contacts each of the first wall and the second wall at the same time when the first wall and the second wall are passed by the front edge of the blade.

In the plate cylinder described above, it is desirable that the first wall and the second wall be set at a length so as to overlap in the width direction of the concave groove section.

Due to the first wall and the second wall being a length so as to overlap in the width direction of the concave groove section, the blade or the blanket roll necessarily contacts at least one of the first wall and the second wall when the concave groove section is passed by the front edge of the blade or the blanket roll.

In the plate cylinder described above, it is desirable that the wall be integrally formed using the same material as a portion of the pattern plate other than the wall.

Due to the wall being integrally formed using the same material as a portion of the pattern plate other than the wall, the wall and the portion of the pattern plate other than the wall are formed at the same time in the manufacturing of the pattern plate.

According to another embodiment of the present disclosure, there is provided a printing device which is provided with a plate cylinder which has a base body with a cylindrical shape which is rotated in a predetermined direction and a pattern plate which is provided on an outer circumference surface of the base body and is rotated integrally with the base body and where a plurality of concave sections, which configures a predetermined printing pattern and is filled with conductive ink, is formed, a blade which contacts the outer circumference surface of the pattern plate and wipes away the conductive ink which protrudes from the concave sections, and a blanket roll which contacts the outer circumference surface of the pattern plate, to which the conductive ink is transferred, and which performs printing by transferring the transferred conductive ink to a printing medium, where a wall, which regulates infiltration of the blade and the blanket roll into the concave sections, is provided in the concave sections.

Accordingly, in the printing device, the blade contacts the wall when the conductive ink which protrudes from the concave sections of the pattern plate is wiped away using the blade.

In addition, in the printing device, the blanket roll contacts the wall when the conductive ink which is filled into the concave sections is transferred to the blanket roll and a portion of the blanket roll which is pressed against the wall is not elastically deformed in the depth direction of the concave sections.

In the printing device described above, it is desirable that the concave sections be formed as a concave groove section where a portion is a groove shape and the wall extends in the width direction of the concave groove section.

Due to the wall extending in the width direction of the concave groove section, there is a state where the wall extends in a direction which is perpendicular with regard to the extension direction of the concave groove section.

In the printing device described above, it is desirable that the wall extends in a direction which is perpendicular to the rotation axis of the base body.

Due to the wall extending in a direction which is perpendicular to the rotation axis of the base body, the wall moves in a direction which is perpendicular to the rotation axis when the plate cylinder is rotating.

In the printing device described above, it is desirable that a plurality of the walls be provided in the extension direction of the concave groove section.

Due to the plurality of walls being provided in the extension direction of the concave groove section, the wall contacts different portions of each of the blade and the blanket roll when the plate cylinder is rotating.

In the printing device described above, it is desirable that both edges of the wall be each continuous with opening edges of the concave groove section on sides which are opposite in the width direction.

Due to both edges of the wall being continuous with the opening edges of the concave groove section on sides which are opposite in the width direction, when the concave groove section is passed by the front edge of the blade or the blanket roll, the front edge of the blade or the blanket roll is typically in contact with the wall when passing.

In the printing device described above, it is desirable that the wall have a first wall where one edge is continuous with one opening edge of the concave groove section in the width direction and the other edge is separated from the other opening edge of the concave groove section in the width direction, and a second wall where one edge is continuous with the other opening edge of the concave groove section in the width direction and the other edge is separated from the one opening edge of the concave groove section in the width direction.

Due to the wall having the first wall where one edge is continuous with one opening edge and the other edge is separated from the other opening edge and the second wall where one edge is continuous with the other opening edge and the other edge is separated from the one opening edge, there is a state where the first wall and the second wall do not cross the concave groove section.

In the printing device described above, it is desirable that the first wall and the second wall be alternately provided by being separated in the extension direction of the concave groove section.

Due to the first wall and the second wall being alternately provided by being separated in the extension direction of the concave groove section, each portion of the blade in the extension direction of the front edge contacts each of the first wall and the second wall at the same time when the first wall and the second wall are passed by the front edge of the blade.

In the printing device described above, it is desirable that the first wall and the second wall be set at a length so as to overlap in the width direction of the concave groove section.

Due to the first wall and the second wall being a length so as to overlap in the width direction of the concave groove section, the blade or the blanket roll necessarily contacts at least one of the first wall and the second wall when the concave groove section is passed by the front edge of the blade or the blanket roll.

In the printing device described above, it is desirable that the wall be integrally formed using the same material as a portion of the pattern plate other than the wall.

Due to the wall being integrally formed using the same material as a portion of the pattern plate other than the wall, the wall and the portion of the pattern plate other than the wall are formed at the same time in the manufacturing of the pattern plate.

According to still another embodiment of the present disclosure, there is provided a printing method which includes filling conductive ink into concave sections of a plate cylinder which has a base body with a cylindrical shape which is rotated in a predetermined direction and a pattern plate which is provided on an outer circumference surface of the base body and is rotated integrally with the base body and where a plurality of the concave sections, which configures a predetermined printing pattern and, is formed and a wall is provided in the concave sections, wiping away the conductive ink which protrudes from the concave sections using a blade which contacts the outer circumference surface of the pattern plate and the wall, transferring the conductive ink which is filled into the concave sections to a blanket roll which contacts the outer circumference surface of the pattern plate and the wall, and performing printing by transferring the conductive ink which is transferred to the blanket roll to a printing medium.

Accordingly, in the printing method, the blade contacts the wall when the conductive ink which protrudes from the concave sections of the pattern plate is wiped away using the blade.

In addition, in the printing method, the blanket roll contacts the wall when the conductive ink which is filled into the concave sections is transferred to the blanket roll and a portion of the blanket roll which is pressed against the wall is not elastically deformed in the depth direction of the concave sections.

The plate cylinder of the present disclosure is provided with the base body with a cylindrical shape which is rotated in a predetermined direction and the pattern plate which is provided on the outer circumference surface of the base body and is rotated integrally with the base body and where the plurality of concave sections, which configures a predetermined printing pattern and is filled with conductive ink, is formed, where the blade, which wipes away the conductive ink which protrudes from the concave sections, contacts the outer circumference surface of the pattern plate, the blanket roll, to which the conductive ink is transferred and which performs printing by transferring the transferred conductive ink to a printing medium, contacts the outer circumference surface of the pattern plate, and the wall, which regulates infiltration of the blade and the blanket roll into the concave sections, is provided in the concave sections.

Accordingly, since the blade contacts the wall when the conductive ink which protrudes from the concave sections of the pattern plate is wiped away using the blade, it is possible to regulate the infiltration of the blade into the concave sections using the wall and it is possible to reduce printing defects with regard to the printing medium.

In addition, since the portion of the blanket roll which is pressed against the wall is not elastically deformed in the depth direction of the concave sections when the conductive ink which is filled into the concave sections is transferred to the blanket roll, it is possible to regulate the infiltration of the blanket roll into the concave sections using the wall and it is possible to reduce printing defects with regard to the printing medium.

In an embodiment of the present disclosure, the concave sections are formed as the concave groove section where a portion is a groove shape and the wall extends in the width direction of the concave groove section.

Accordingly, since there is a state where the wall extends in a direction which is perpendicular with regard to the extension direction of the concave groove section, it is possible to reliably regulate the infiltration of the blade and the blanket roll into the concave groove section using the wall.

In an embodiment of the present disclosure, the wall extends in a direction which is perpendicular to the rotation axis of the base body.

Accordingly, since the wall moves in a direction which is perpendicular to the rotation axis when the plate cylinder is rotating, it is possible to reliably regulate the infiltration of the blade and the blanket roll into the concave groove section using the wall.

In an embodiment of the present disclosure, the plurality of walls is provided in the extension direction of the concave groove section.

Accordingly, since the wall contacts different portions of the blade when the plate cylinder is rotating and it is difficult for the blade to be inclined in the depth direction of the concave groove section, it is possible to reliably regulate the infiltration of the blade into the concave groove section using the wall.

In addition, since the wall contacts different portions of the blanket roll when the plate cylinder is rotating and the amount of deformation in a portion of the blanket roll which is positioned between the walls is reduced, it is possible to regulate excessive infiltration of the blanket roll into the concave groove section using the wall.

In an embodiment of the present disclosure, both edges of the wall are each continuous with opening edges of the concave groove section on sides which are opposite in the width direction.

Accordingly, since, when the concave groove section is passed by the front edge of the blade or the blanket roll, the front edge of the blade or the blanket roll is typically in contact with the wall when passing, it is possible to reliably regulate the infiltration of the blade and the blanket roll into the concave groove section using the wall.

In an embodiment of the present disclosure, the wall has a first wall where one edge is continuous with one opening edge of the concave groove section in the width direction and the other edge is separated from the other opening edge of the concave groove section in the width direction and a second wall where one edge is continuous with the other opening edge of the concave groove section in the width direction and the other edge is separated from the one opening edge of the concave groove section in the width direction.

Accordingly, since there is a state where the first wall and the second wall do not cross the concave groove section, it is possible to use a material with low fluidity as the conductive ink and it is possible to expand the selection options of materials which are able to be used as the conductive ink.

In an embodiment of the present disclosure, the first wall and the second wall are alternately provided by being separated in the extension direction of the concave groove section.

Accordingly, since each portion of the blade in the extension direction of the front edge contacts each of the first wall and the second wall at the same time when the first wall and the second wall are passed by the front edge of the blade, it is difficult for the blade to be inclined in the depth direction of the concave groove section and it is possible to reliably regulate the infiltration of the blade into the concave groove section using the first and the second wall.

In an embodiment of the present disclosure, the first wall and the second wall are set to a length so as to overlap in the width direction of the concave groove section.

Accordingly, since the blade or the blanket roll necessarily contacts at least one of the first wall and the second wall when the concave groove section is passed by the front edge of the blade or the blanket roll, it is possible to more reliably regulate the infiltration of the blade and the blanket roll into the concave groove section using the first wall and the second wall.

In an embodiment of the present disclosure, the wall is integrally formed using the same material as a portion of the pattern plate other than the wall.

Accordingly, it is possible to reduce the number of processes when manufacturing the plate cylinder and it is possible to achieve a reduction in the manufacturing costs of the plate cylinder.

The printing device of the present disclosure is provided with the plate cylinder which has the base body with a cylindrical shape which is rotated in a predetermined direction and the pattern plate which is provided on the outer circumference surface of the base body and is rotated integrally with the base body and where the plurality of concave sections, which configures a predetermined printing pattern and is filled with conductive ink, is formed, the blade which contacts the outer circumference surface of the pattern plate and wipes away the conductive ink which protrudes from the concave sections, and the blanket roll which contacts the outer circumference surface of the pattern plate, to which the conductive ink is transferred, and which performs printing by transferring the transferred conductive ink to the printing medium, where the wall, which regulates infiltration of the blade and the blanket roll into the concave sections, is provided in the concave sections.

Accordingly, since the blade contacts the wall when the conductive ink which protrudes from the concave sections of the pattern plate is wiped away using the blade, it is possible to regulate the infiltration of the blade into the concave sections using the wall and it is possible to reduce printing defects with regard to the printing medium.

In addition, since the portion of the blanket roll which is pressed against the wall is not elastically deformed in the depth direction of the concave sections when the conductive ink which is filled into the concave sections is transferred to the blanket roll, it is possible to regulate the infiltration of the blanket roll into the concave sections using the wall and it is possible to reduce printing defects with regard to the printing medium.

In an embodiment of the present disclosure, the concave sections are formed as the concave groove section where a portion is a groove shape and the wall extends in the width direction of the concave groove section.

Accordingly, since there is a state where the wall extends in a direction which is perpendicular with regard to the extension direction of the concave groove section, it is possible to reliably regulate the infiltration of the blade and the blanket roll into the concave sections using the wall.

In an embodiment of the present disclosure, the wall extends in a direction which is perpendicular to the rotation axis of the base body.

Accordingly, since the wall moves in a direction which is perpendicular to the rotation axis when the plate cylinder is rotating, it is possible to reliably regulate the infiltration of the blade and the blanket roll into the concave groove section using the wall.

In an embodiment of the present disclosure, the plurality of walls is provided in the extension direction of the concave groove section.

Accordingly, since the wall contacts different portions of the blade when the plate cylinder is rotating and it is difficult for the blade to be inclined in the depth direction of the concave groove section, it is possible to reliably regulate the infiltration of the blade into the concave groove section using the wall.

In addition, since the wall contacts different portions of the blanket roll when the plate cylinder is rotating and the amount of deformation in a portion of the blanket roll which is positioned between the walls is reduced, it is possible to regulate excessive infiltration of the blanket roll into the concave groove section using the wall.

In an embodiment of the present disclosure, both edges of the wall are each continuous with opening edges of the concave groove section on sides which are opposite in the width direction.

Accordingly, since, when the concave groove section is passed by the front edge of the blade or the blanket roll, the front edge of the blade or the blanket roll is typically in contact when passing, it is possible to reliably regulate the infiltration of the blade and the blanket roll into the concave groove section using the wall.

In an embodiment of the present disclosure, the wall has a first wall where one edge is continuous with one opening edge of the concave groove section in the width direction and the other edge is separated from the other opening edge of the concave groove section in the width direction and a second wall where one edge is continuous with the other opening edge of the concave groove section in the width direction and the other edge is separated from the one opening edge of the concave groove section in the width direction.

Accordingly, since there is a state where the first wall and the second wall do not cross the concave groove section, it is possible to use a material with low fluidity as the conductive ink and it is possible to expand the selection options of materials which are able to be used as the conductive ink.

In an embodiment of the present disclosure, the first wall and the second wall are alternately provided by being separated in the extension direction of the concave groove section.

Accordingly, since each portion of the blade in the extension direction of the front edge contacts each of the first wall and the second wall at the same time when the first wall and the second wall are passed by the front edge of the blade, it is difficult for the blade to be inclined in the depth direction of the concave groove section and it is possible to reliably regulate the infiltration of the blade into the concave groove section using the first wall and the second wall.

In an embodiment of the present disclosure, the first wall and the second wall are set to a length so as to overlap in the width direction of the concave groove section.

Accordingly, since the blade or the blanket roll necessarily contacts at least one of the first wall and the second wall when the concave groove section is passed by the front edge of the blade or the blanket roll, it is possible to more reliably regulate the infiltration of the blade and the blanket roll into the concave groove section using the first wall and the second wall.

In an embodiment of the present disclosure, the wall is integrally formed using the same material as a portion of the pattern plate other than the wall.

Accordingly, it is possible to reduce the number of processes when manufacturing the plate cylinder and it is possible to achieve a reduction in the manufacturing costs of the plate cylinder.

The printing method of the present disclosure includes filling conductive ink into the concave sections of the plate cylinder which has the base body with a cylindrical shape which is rotated in a predetermined direction and the pattern plate which is provided on the outer circumference surface of the base body and is rotated integrally with the base body and where the plurality of concave sections, which configures a predetermined printing pattern, is formed and a wall is provided in the concave sections, wiping away the conductive ink which protrudes from the concave sections using the blade which contacts the outer circumference surface of the pattern plate and the wall, transferring the conductive ink which is filled into the concave sections by the blanket roll which contacts the outer circumference surface of the pattern plate and the wall, and performing printing by transferring the conductive ink which is transferred to the blanket roll to the printing medium.

Accordingly, since the blade contacts the wall when the conductive ink which protrudes from the concave sections of the pattern plate is wiped away using the blade, it is possible to regulate the infiltration of the blade into the concave sections using the wall and it is possible to reduce printing defects with regard to the printing medium.

In addition, since the portion of the blanket roll which is pressed against the wall is not elastically deformed in the depth direction of the concave sections when the conductive ink which is filled into the concave sections is transferred to the blanket roll, it is possible to regulate the infiltration of the blanket roll into the concave sections using the wall and it is possible to reduce printing defects with regard to the printing medium.

Additional features and advantages are described herein, and will be apparent from the following Detailed Description and the figures.

### BRIEF DESCRIPTION OF THE FIGURES

FIG. 1 illustrates a plate cylinder, a printing device, and a printing method according to an embodiment of the present disclosure along with FIGS. 2 to 17 and is a conceptual side surface diagram of a printing device diagram;

FIG. 2 is an enlarged conceptual diagram illustrating a printing pattern which is formed on a plate cylinder;

FIG. 3 is an enlarged conceptual diagram illustrating positioning and orientation of a wall which is provided in a concave groove section of a pattern plate;

FIG. 4 is a conceptual perspective diagram illustrating a state where a blade contacts a plate cylinder;

FIG. 5 is an enlarged side surface diagram illustrating a state where a blade contacts a plate cylinder;

FIG. 6 is an enlarged conceptual diagram illustrating a state where a blade contacts a wall which is provided in a concave section;

FIG. 7 is an enlarged conceptual diagram illustrating a state where an intermediate pattern is formed using conductive ink which is transferred to a printing medium;

FIG. 8 is an enlarged conceptual diagram illustrating a state where a wiring pattern is formed using fluidity of conductive ink;

FIG. 9 illustrates a first modified example of a plate cylinder along with FIGS. 10 and 11 and is an enlarged conceptual diagram illustrating positioning and orientation of a concave groove section of a wall of a first modified example;

FIG. 10 is another example of the first modified example of a plate cylinder and is an enlarged conceptual diagram illustrating positioning and orientation of a concave groove section of a wall of a different first modified example;

FIG. 11 is another example of the first modified example of a plate cylinder which is different to FIG. 10 and is an enlarged conceptual diagram illustrating positioning and orientation of a concave groove section of a wall of the other first modified example;

FIG. 12 illustrates a second modified example of a plate cylinder along with FIGS. 14, 16, and 17 and is an enlarged conceptual diagram illustrating positioning and orientation of a concave groove section of a wall of a second modified example;

FIG. 13 is an enlarged conceptual diagram illustrating an intermediate pattern according to the second modified example;

FIG. 14 is another example of the second modified example of a plate cylinder and is an enlarged conceptual diagram illustrating positioning and orientation of a concave groove section of a wall of the other second modified example;

FIG. 15 is an enlarged conceptual diagram illustrating an intermediate pattern according to the other second modified example;

FIG. 16 is another example of the second modified example of a plate cylinder which is different to FIG. 14 and is an enlarged conceptual diagram illustrating positioning and orientation of a concave groove section of a wall of the other second modified example;

FIG. 17 is another example of the second modified example of a plate cylinder which is different to FIG. 16 and is an enlarged conceptual diagram illustrating positioning and orientation of a concave groove section of a wall of the other second modified example; and

FIGS. 18A and 18B are process diagrams illustrating typical transfer defects from a pattern plate to a blanket roll, FIG. 18A is an enlarged conceptual diagram illustrating a state where the blanket roll has infiltrated a concave section of a pattern plate, and FIG. 18B is an enlarged conceptual diagram illustrating typical transfer defects to a blanket roll.

### DETAILED DESCRIPTION

Below, embodiments of a plate cylinder, a printing device, and a printing method of the present disclosure will be described with reference to attached diagrams.

In the optimal embodiments described below, the printing device of the present disclosure is applied to a printing device which performs gravure offset printing, the plate cylinder of the present disclosure is applied to a plate cylinder which is provided in a printing device which performs gravure offset printing, and the printing method of the present disclosure is applied to a printing method using a printing device which performs gravure offset printing.

Here, the application range of the printing device, the plate cylinder, and the printing method of the present disclosure are not respectively limited to a printing device which performs gravure offset printing, a plate cylinder which is provided in the printing device, or a printing method using the printing device. It is possible for the printing device, the plate cylinder, and the printing method of the present disclosure to be widely applied to various types of printing devices which perform printing by unnecessary ink being wiped away using a blade with regard to a plate cylinder where concave sections are provided via a blanket roll, plate cylinders which are provided in the various types of printing devices, and printing method using various types of printing devices.

In the description below, as an example, direction is shown in a state where a printing medium such as a glass substrate is disposed with an orientation which faces an up and down direction, but in relation to the embodiments of the present disclosure, there is no limitation with regard to this direction.

### [Configuration of Printing Device]

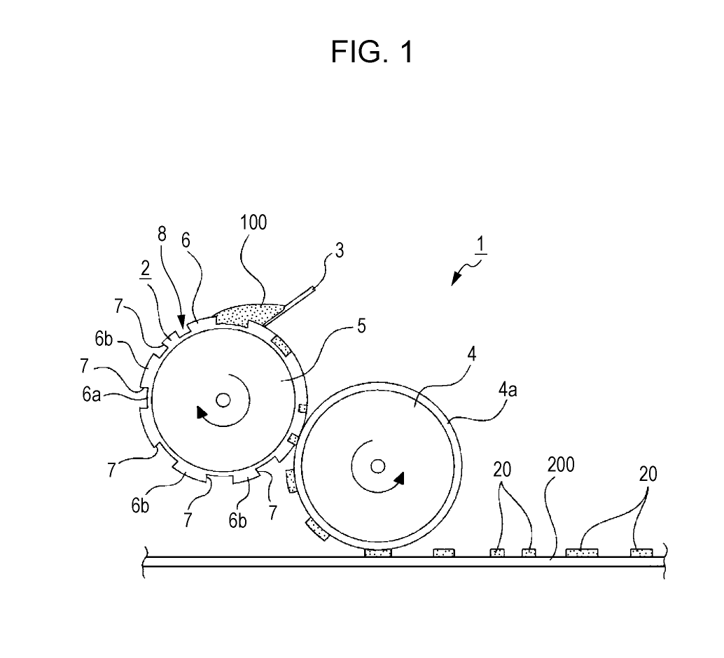

A printing device 1 is provided with a blade 3 which contacts a plate cylinder 2 with a cylindrical shape and the outer circumference surface of the plate cylinder 2 and a blanket roll 4 which contacts the outer circumference surface of the plate cylinder 2 as shown in FIG. 1.

The plate cylinder 2 has a base body 5 with a cylindrical shape and a pattern plate 6 which is provided in the outer circumference surface of the base body 5.

The base body 5 is, for example, formed using a glass material such as quartz glass, is supported by a supporting mechanism which is not shown, and is rotated in a predetermined direction.

The pattern plate 6 is, for example, formed by a resist which is a light sensitive resin which has a constant strength. A plurality of concave sections 7, 7, . . . are formed in the pattern plate 6. A portion which is positioned further to the base body 5 side than the concave sections 7, 7, . . . of the pattern plate 6 is provided as a base bottom section 6a and a portion between the concave sections 7, 7, . . . of the pattern plate 6 is provided as protrusion sections 6b, 6b, . . . which each protrude to the outside from the base bottom section 6a. The pattern plate 6 is rotated integrally with the base body 5.

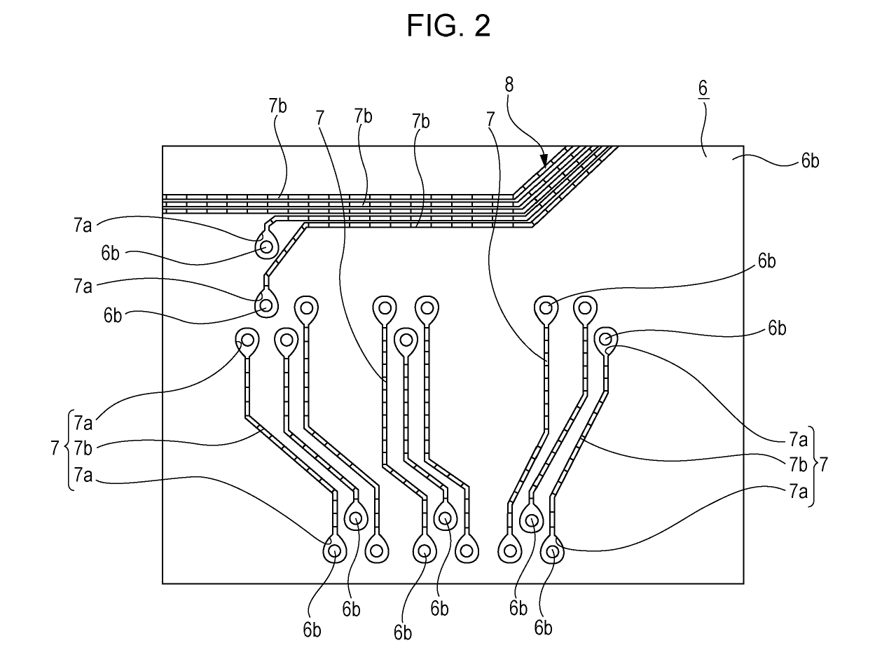

A predetermined printing pattern 8 is configured using the concave sections 7, 7, . . . (refer to FIG. 2). The concave section 7 is, for example, formed from connection sections 7a and 7a with an annular shape and a concave groove section 7b with a groove shape which extends in a predetermined direction. The connection sections 7a and 7a is, for example, formed to be continuous with both edges of the concave groove section 7b. In the concave groove sections 7b, 7b, . . . , there is a formation which extends in a direction which is parallel with the rotation axis of the plate cylinder 2, a formation which extends in a direction which is perpendicular with the rotation axis of the plate cylinder 2, and a formation which extends in a direction which is inclined with regard to the rotation axis of the plate cylinder 2.

The concave sections 7, 7, . . . are, for example, formed by exposure and development of a resist which is coated on the outer circumference surface of the base body 5 using a blue laser or the like. At this time, in a case where a negative type resist is used as the resist which is coated, a portion which is exposed is formed as the protrusion sections 6b, 6b, . . . and a portion which is not exposed is formed as the concave sections 7, 7, . . . . On the other hand, in a case where a positive type resist is used as the resist which is coated, a portion which is exposed is formed as the concave sections 7, 7, . . . and a portion which is not exposed is formed as the protrusion sections 6b, 6b, . . . . The concave groove section 7b has a groove width of, for example, 20 μm and a groove depth of, for example, 4.2 μm.

Conductive ink 100 which has fluidity is filled into the concave sections 7, 7, . . . (refer to FIG. 1). The conductive ink 100 is filled into the concave sections 7, 7, . . . by being supplied to the plate cylinder 2 from an ink supplying device which is not shown. At this time, the conductive ink 100 may protrude from the concave sections 7, 7, . . . due to the supply amount, positional deviation in the supply, or the like of the conductive ink 100 with regard to the concave sections 7, 7, . . . , but the conductive ink 100 which protrudes is wiped away using the blade 3.

After printing with regard to a printing medium, the conductive ink 100 which is filled into the connection sections 7a, 7a, . . . becomes a portion where electronic components or the like are connected. After printing with regard to a printing medium, the conduction ink 100 which is filled into the concave groove sections 7b, 7b, . . . becomes a portion which connects between electronic components. As the conductive ink 100, for example, silver nano ink or the like are able to be used.

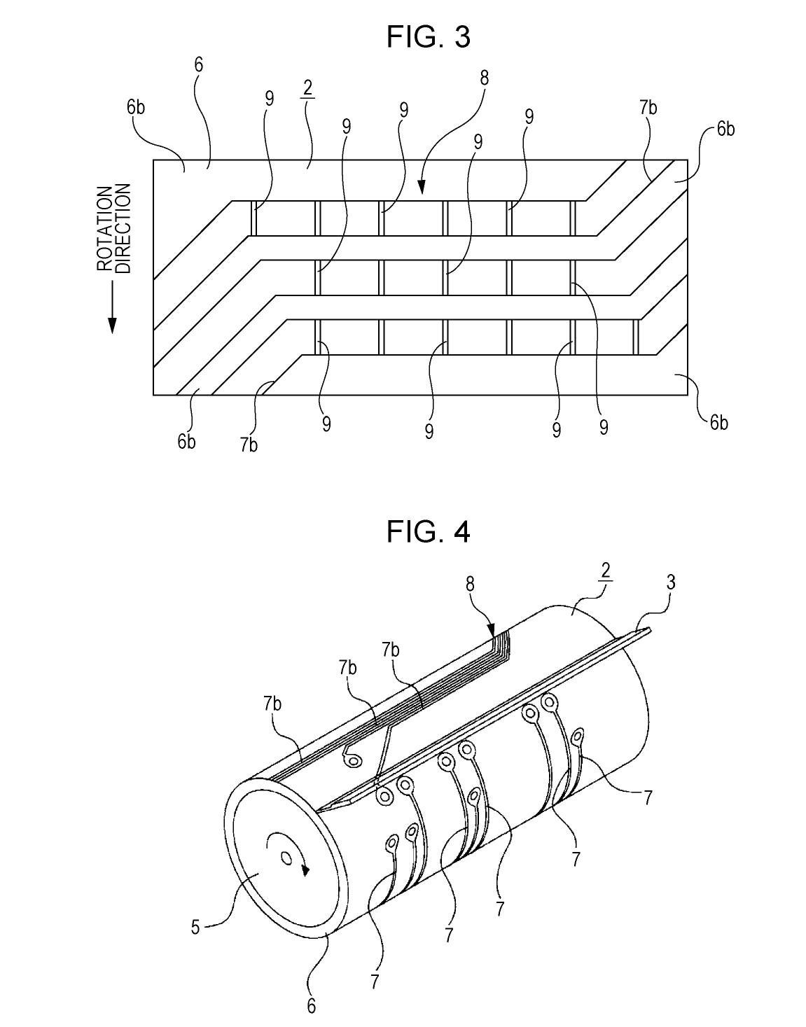

Walls 9, 9, . . . are provided in the concave sections 7, 7, . . . (refer to FIG. 3). The walls 9, 9, . . . have a function of regulating the infiltration of the blade 3 and the blanket roll 4 into the concave sections 7, 7, . . . .

The walls 9, 9, . . . are, for example, formed integrally using a resist which is the same material as portions of the pattern plate 6 other than the walls 9, 9, . . . . The walls 9, 9, . . . have a thickness of, for example 1 μm. The walls 9, 9, . . . have a height which is, for example, the same as the depth of the concave sections 7, 7, . . . . The walls 9, 9, . . . are, for example, provided in the concave groove section 7b which extends in a direction which is parallel with the rotation axis of the plate cylinder 2. The walls, 9, 9, . . . have a width which is the same as the width of the concave groove section 7b and both edges are each continuous with an opening edge on a side opposite to the concave groove section 7b in the width direction. That is, the walls 9, 9, . . . are provided to cross the concave groove section 7b in the width direction of the concave groove section 7b and are provided so as to be perpendicular with regard to the extension direction of the concave groove section 7b. The walls 9, 9, . . . are, for example, provided to be separated in the extension direction of the concave groove section 7b.

Here, in the description above, an example is shown where the walls 9, 9, . . . which are provided in the concave sections 7, 7, . . . are integrally formed using the same material as the portions of the pattern plate 6 other than the walls 9, 9, . . . , but the walls 9, 9, . . . are not limited to being integrally formed with the portions of the pattern plate 6 other than the walls 9, 9, . . . . The walls 9, 9, . . . may be formed separately to the portions of the pattern plate 6 other than the walls 9, 9, . . . . In addition, the walls 9, 9, . . . may be formed by a material which is different to the portions of the pattern plate 6 other than the walls 9, 9, . . . .

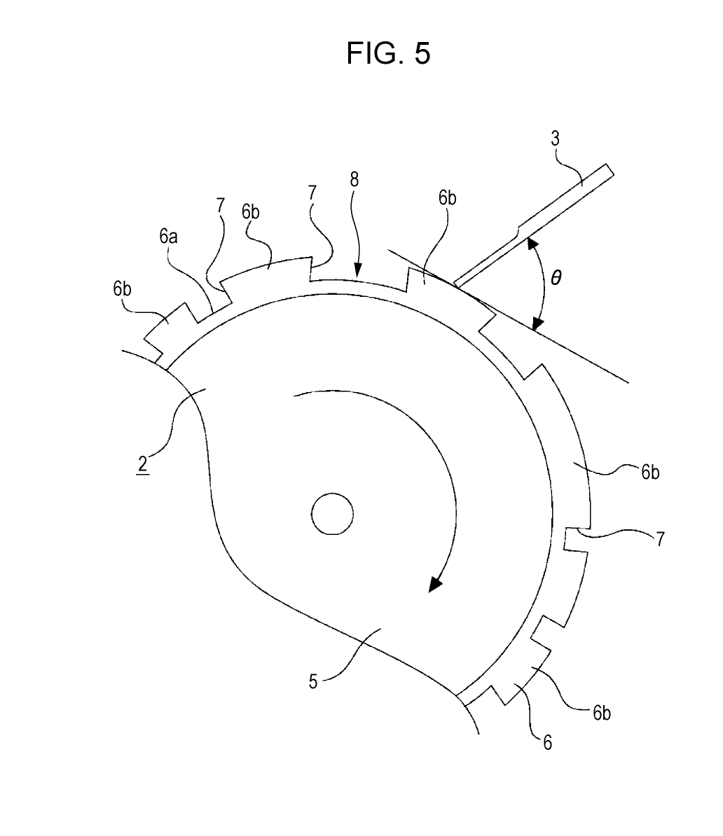

The blade 3 is formed so that the front edge has a shape of a sharp knife and is disposed in a state so that the front edge is in contact with the outer circumference surface of the pattern plate 6 (refer to FIG. 4). The blade 3 contacts in a state of being inclined with a predetermined angle θ, for example, an angle of approximately 65°, with regard to the connection direction of the outer circumference surface of the plate cylinder 2 (refer to FIG. 5). The blade 3 is disposed so that the extension direction of the front edge is perpendicular with the extension direction of the walls 9, 9, . . . which are provided in the concave groove section 7b which extends in a direction which is parallel with the rotation axis of the plate cylinder 2. The blade 3 is in a state of being held by a holding device with an air cylinder, a spring, or the like which is not shown and being in contact with the outer circumference surface of the pattern plate 6. Out of the conductive ink 100 which is supplied to the plate cylinder 2 using the blade 3, the conductive ink 100 which protrudes from the concave sections 7, 7, . . . of the pattern plate 6 is wiped away.

The blanket roll 4 is formed in a cylindrical shape and has a transfer section 4a which is formed in the outer circumference section using a material with elasticity such as rubber (refer to FIG. 1). The blanket roll 4 contacts the outer circumference surface of the pattern plate 6 and is rotated in a direction which is opposite to the plate cylinder 2 in accompaniment with the rotation of the plate cylinder 2. When the plate cylinder 2 and the blanket roll 4 are rotated, the conductive ink 100 which is filled into the concave sections 7, 7, . . . of the plate cylinder 2 is transferred to the transfer section 4a. The conductive ink 100 which is transferred to the transfer section 4a is printed by being transferred to a printing medium 200.

The printing medium 200 is, for example, a transparent glass plate which is used in liquid crystal displays or the like. Here, as the printing medium 200, for example, it is possible to use a member with a plate shape which is formed using resin or metal. A wiring pattern 20 is formed on the printing medium 200 by printing due to the conductive ink 100 which is transferred to the blanket roll 4 being transferred.

### [Printing Method]

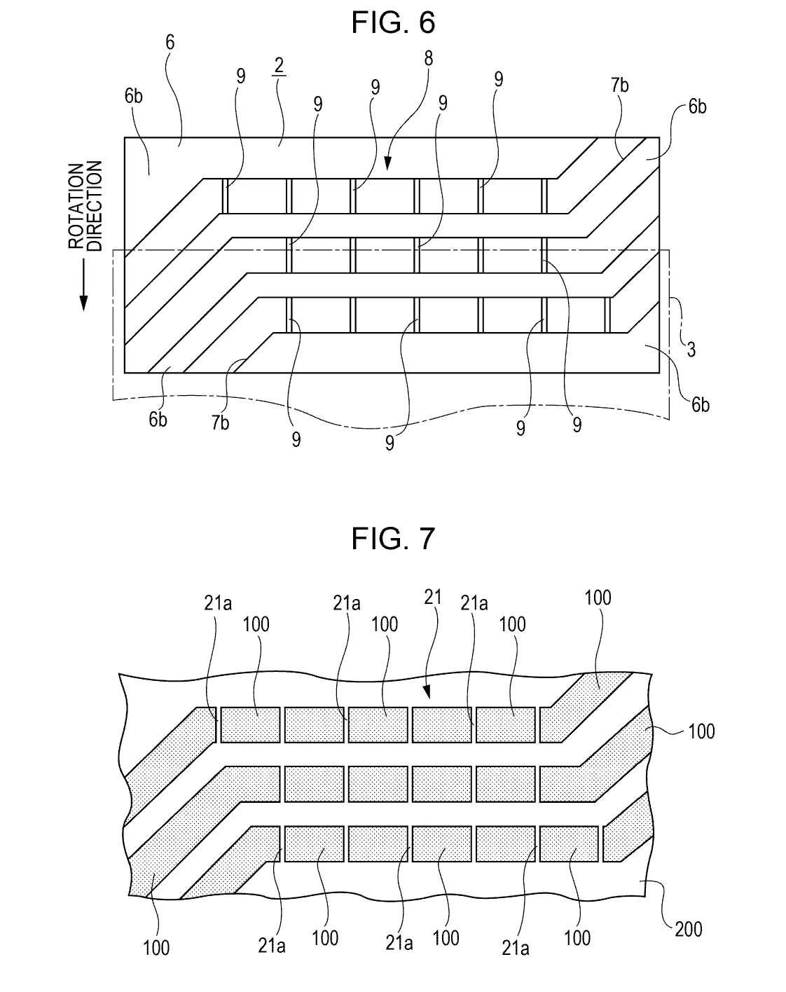

Below, a printing method using the printing device 1 described above will be described (with reference to FIGS. 1, 6, to 8).

First, the conductive ink 100 is supplied from an ink supply device in the pattern plate 6 of the plate cylinder 2 which is rotated in a predetermined direction and the conductive ink 100 is filled into the concave sections 7, 7, . . . which are formed in the pattern plate 6 (refer to FIG. 1). At this time, as described above, the conductive ink 100 may protrude from the concave sections 7, 7, . . . .

When the plate cylinder 2 is rotating as described above, the conductive ink 100 which protrudes from the concave sections 7, 7, . . . of the pattern plate 6 is wiped away using the blade 3 which is in contact with the outer circumference surface of the pattern plate 6.

At this time, the front edge of the blade 3 rubs against the walls 9, 9, . . . which move in accompaniment with the rotation of the plate cylinder 2 which is provided with the concave groove sections 7b, 7b, . . . (refer to FIG. 6). Since the walls 9, 9, . . . extend in the width direction of the concave groove sections 7b, 7b, . . . , it is possible to reliably regulate the infiltration of the blade 3 into the concave groove sections 7b, 7b, . . . using the walls 9, 9, . . . .

In addition, since the walls 9, 9, . . . are provided to extend in a direction which is perpendicular to the extension direction of the front edge of the blade 3, the walls 9, 9, . . . move in a direction which is perpendicular with regard to the extension direction of the blade 3 when the plate cylinder 3 is rotated. Accordingly, it is possible to reliably regulate the infiltration of the blade 3 into the concave groove sections 7b, 7b, . . . using the walls 9, 9, . . . .

In addition, since the interval of the walls 9, 9 is constant irrespective of the position in the width direction of the concave groove section 7b and the positional relationship of the blade 3 and the walls 9, 9, . . . , which move in a direction which is perpendicular with regard to the extension direction of the blade 3, does not change, it is possible to reliably regulate the infiltration of the blade 3 into the concave groove sections 7b, 7b, . . . using the walls 9, 9, . . . .

Furthermore, since the walls 9, 9, . . . are provided to be separated in the extension direction of the concave groove section 7b, each portion of the blade 3 in the extension direction of the front edge rubs against the walls 9, 9, . . . at the same time. Accordingly, since it is difficult for the blade 3 to be inclined in the depth direction of the concave groove section 7b, it is possible to reliably regulate the infiltration of the blade 3 into the concave groove sections 7b, 7b, . . . using the walls 9, 9, . . . .

Furthermore, in addition, since the walls 9, 9, . . . are provided so as to cross the concave groove section 7b, which extends in a direction which is parallel to the rotation axis of the plate cylinder 2, in the width direction, when the concave groove sections 7b, 7b, . . . are passed by the front edge of the blade 3, the front edge of the blade 3 is typically in contact with the walls 9, 9, . . . when passing by. Accordingly, it is possible to more reliably regulate the infiltration of the blade 3 into the concave groove sections 7b, 7b, . . . using the walls 9, 9, . . . .

In addition, the walls 9, 9, . . . have a height which is the same as the depth of the concave groove sections 7b, 7b, . . . . Accordingly, since the front edge of the blade 3 is in smooth contact from the protrusion sections 6b, 6b, . . . to the walls 9, 9, . . . of the pattern plate 6, it is possible to reliably regulate the infiltration of the blade 3 into the concave groove sections 7b, 7b, . . . using the walls 9, 9, . . . .

In addition, since the walls 9, 9, . . . have a height which is the same as the depth of the concave groove sections 7b, 7b, . . . , an unnecessary load is not applied with regard to the rotation of the plate cylinder 2 or the blade 3 without the blade 3 eating into the walls 9, 9, . . . when the plate cylinder 2 is rotating. Accordingly, it is possible to achieve a smoothening of the rotation operation of the plate cylinder 2 and the wiping operation of the conductive ink 100 using the blade 3.

Next, the conductive ink 100, which is filled into the concave sections 7, 7, . . . which has been passed by the blade 3, is transferred to the transfer section 4a of the blanket roll 4 which is rotated in accompaniment with the rotation of the plate cylinder 2 (refer to FIG. 1).

At this time, the transfer section 4a which is rotated in accompaniment with the rotation of the plate cylinder 2 is pressed against the walls 9, 9, . . . which move in accompaniment with the rotation of the plate cylinder 2. Since the walls 9, 9, . . . extend in the width direction of the concave groove sections 7b, 7b, . . . , it is possible to reliably regulate the infiltration of the transfer section 4a of the blanket roll 4 into the concave groove sections 7b, 7b, . . . using the walls 9, 9, . . . .

In addition, since the walls 9, 9, . . . extend in a direction which is perpendicular to the rotation axis of the plate cylinder 2, the walls 9, 9, . . . move in a direction which is perpendicular to the rotation axis of the plate cylinder 2 when the plate cylinder 2 is rotating. Accordingly, it is possible to reliably regulate the infiltration of the transfer section 4a into the concave groove sections 7b, 7b, . . . using the walls 9, 9, . . . .

Furthermore, since the walls 9, 9, . . . are provided to be separated in the extension direction of the concave groove section 7b, the amount of deformation of a portion of the transfer section 4a, which is formed using a material which has elasticity, which is positioned between the walls 9, 9, . . . , is reduced. Accordingly, it is possible to reliably regulate excessive infiltration of the transfer section 4a into the concave groove sections 7b, 7b, . . . using the walls 9, 9, . . . .

Furthermore, in addition, since the walls 9, 9, . . . are provided so as to cross the concave groove section 7b, which extends in a direction which is parallel to the rotation axis of the plate cylinder 2, in the width direction, when the concave groove sections 7b, 7b, . . . are passed by the transfer section 4a of the blanket roll 4, the transfer section 4a is typically in contact with the walls 9, 9, . . . when passing by. Accordingly, it is possible to more reliably regulate the infiltration of the transfer section 4a into the concave groove sections 7b, 7b, . . . using the walls 9, 9, . . . .

Next, the conductive ink 100 which is transferred to the transfer section 4a of the blanket roll 4 is printed by being transferred to the printing medium 200 (refer to FIG. 1).

When the conductive ink 100 is transferred to the printing medium 200, an intermediate pattern 21 which is substantially the same shape as the printing pattern 8 is formed using the conductive ink 100 which is transferred to the printing medium 200 as shown in FIG. 7. The intermediate pattern 21 has notch sections 21, 21a, . . . which occur due to the walls 9, 9, . . . . That is, the intermediate pattern 21 has a shape in a state where a portion of the printing pattern 8 is interrupted.

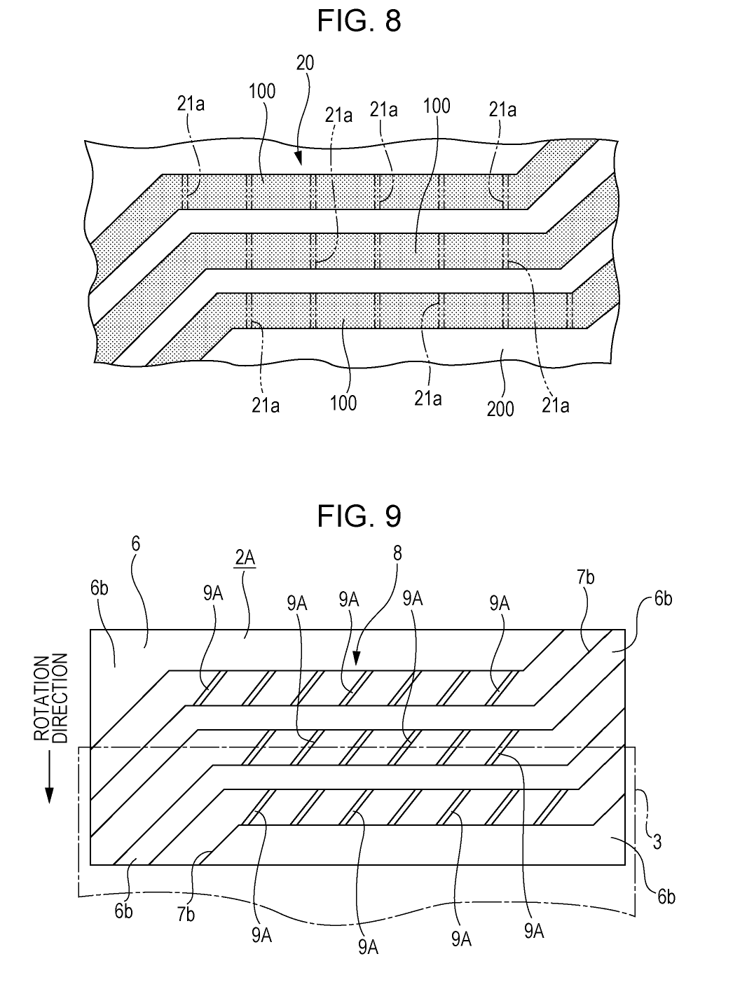

When the intermediate pattern 21 is formed using the conductive ink 100, the conductive ink 100 which has fluidity slightly flows on the printing medium 200 (refer to FIG. 8). Accordingly, the intermediate pattern 21 is connected in a straight line by the notch sections 21a, 21a, . . . in the intermediate pattern 21 being closed in due to the fluidity of the conductive ink 100 and the wiring pattern 20 is formed in a state where conduction is possible.

### [Modified Examples of Plate Cylinder]

Below, each modified example of the plate cylinder 2 will be described (with reference to FIGS. 9 to 17).

Here, since the plate cylinders according to each modified examples shown below differ only in the positioning and orientation with regard to the concave groove section of the wall compared to the plate cylinder 2 described above, only the portions which differ compared to the plate cylinder 2 will be described in detail, and with regard to other portions, reference numerals which are attached to the same portions in the plate cylinder 2 will be attached and the description will be omitted.

### FIRST MODIFIED EXAMPLE

Walls 9A, 9A, . . . are provided in a plate cylinder 2A according to a first modified example (refer to FIG. 9). The walls 9A, 9A, . . . are provided in a state where both edges are continuous with the opening edge on a side which is opposite to each of the concave groove sections 7b in the width direction and extend in an inclined direction with regard to the extension direction of the concave groove section 7b. That is, the walls 9A, 9A, . . . are provided to diagonally cross the concave groove section 7b in the width direction of the concave groove section 7b. The walls 9A, 9A, . . . have a thickness of, for example 1 μm, and have a height which is, for example, the same as the depth of the concave groove section 7b. In addition, the walls 9A, 9A, . . . are provided in a state of each extending in the same direction so as to be separated in the extension direction of the concave groove section 7b.

Since the walls 9A, 9A, . . . are provided to extend in an inclined direction with regard to the extension direction of the blade 3, the walls 9A, 9A, . . . move in an inclined direction with regard to the extension direction of the blade 3 when the plate cylinder 2 is rotating. Accordingly, the contact area of the walls 9A, 9A, . . . with regard to the blade 3 is large and it is possible to reliably regulate the infiltration of the blade 3 into the concave groove sections 7b, 7b, . . . using the walls 9A, 9A, . . . . In addition, the contact area of the walls 9A, 9A, . . . with regard to the blanket roll 4 is large and it is possible to reliably regulate the infiltration of the blanket roll 4 into the concave groove sections 7b, 7b, . . . using the walls 9A, 9A, . . . .

In the description above, the plate cylinder 2A, where the walls 9A, 9A, . . . which extend in the same direction in an inclined direction are provided, is shown as the first modified example, but the extension direction of the walls is arbitrary and it is possible to be configured as plate cylinders 2B and 2C below as other examples of the first modified example.

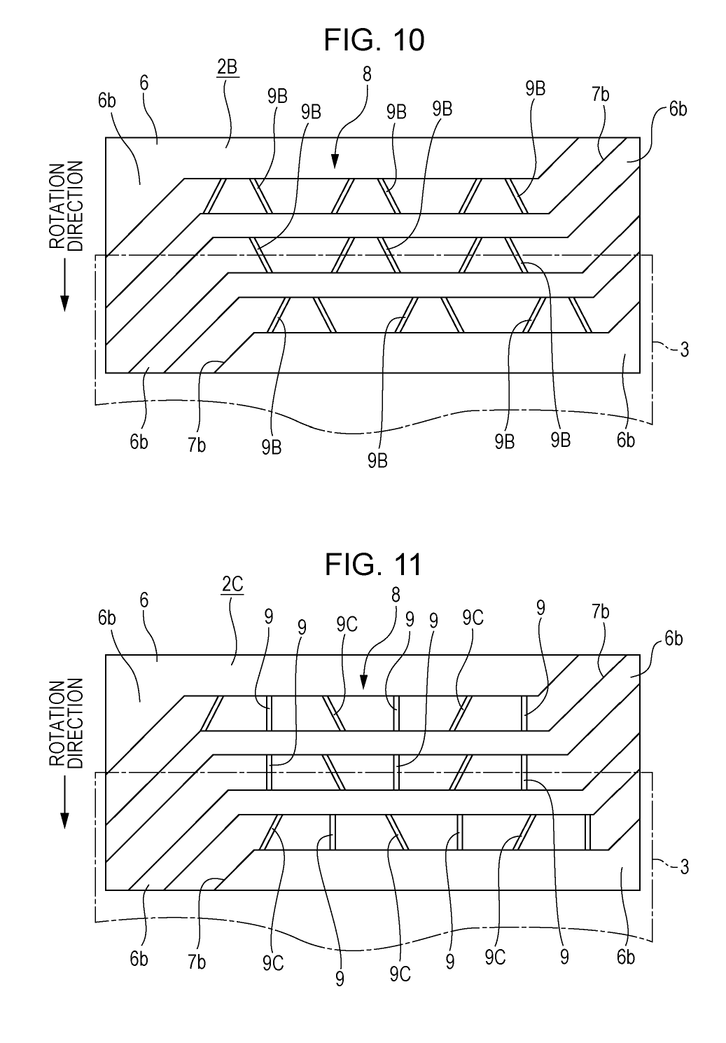

Walls 9B, 9B, . . . are provided in the plate cylinder 2B (refer to FIG. 10). The walls 9B, 9B, . . . are provided in a state of extending in at least two directions which are different in inclined directions with regard to the extension direction of the concave groove section 7b. For example, the walls 9B, 9B, . . . are alternately provided to extend in two directions which are different so as to be separated in the extension direction of the concave groove section 7b.

Here, in the description above, an example is shown where the walls 9B, 9B, . . . are provided to extend in different directions in a regular manner, but the walls 9B, 9B, . . . may not be provided to extend in different directions in a regular manner and may be provided to extend in a plurality of directions which are different in an irregular manner.

Walls 9C, 9C, . . . and the walls 9, 9, . . . are provided in the plate cylinder 2C (refer to FIG. 11). The walls 9C, 9C, . . . are, for example, provided in a state of extending in two directions which are different in inclined directions with regard to the extension direction of the concave groove section 7b. For example, the walls 9C, 9C, . . . and the walls 9, 9, . . . are alternately provided so as to be separated in the extension direction of the concave groove section 7b.

Here, in the description above, an example is shown where the walls 9C, 9C, . . . are provided in a state of extending in two different directions, but the walls 9C, 9C, . . . may not be provided in a state of extending in two different directions. That is, the walls 9C, 9C, . . . may be provided in a state of extending in the same direction in an inclined direction with regard to the extension direction of the concave groove section 7b or may be provided in a state of extending in arbitrary directions which are different in an inclined direction with regard to the extension direction of the concave groove section 7b. In addition, the walls 9C, 9C, . . . and the walls 9, 9, . . . may be provided in an arbitrary order in the extension direction of the concave groove section 7b.

As described above, even with the plate cylinders 2B and 2C, the walls 9B, 9B, . . . and the walls 9C, 9C, . . . , which extend in an inclined direction with regard to the extension direction of the concave groove section 7b, are provided in the same manner as the plate cylinder 2A. Accordingly, the contact area of the walls 9B, 9B, . . . and the walls 9C, 9C, . . . with regard to the blade 3 is large and it is possible to reliably regulate the infiltration of the blade 3 into the concave groove sections 7b, 7b, . . . using the walls 9B, 9B, . . . and the walls 9C, 9C, . . . .

### SECOND MODIFIED EXAMPLE

First walls 10, 10, . . . and second walls 11, 11, . . . are provided in a plate cylinder 2D according to a second modified example (refer to FIG. 12). The walls 10, 10, . . . have one edge continuous with one opening edge in the width direction of the concave groove sections 7b and the other edge separated from the other opening edge in the width direction of the concave groove sections 7b. The second walls 11, 11, . . . have one edge continuous with the other opening edge in the width direction of the concave groove sections 7b and the other edge separated from the one opening edge in the width direction of the concave groove sections 7b.

The first walls 10, 10, . . . and the second walls 11, 11, . . . have a length so as to overlap in the width direction of the concave groove section 7b. That is, a length where the length of the first wall 10 in the width direction of the concave groove section 7b and the length of the second wall 11 in the width direction of the concave groove section 7b is longer than the width of the concave groove section 7b. In addition, the first walls 10, 10, . . . and the second walls 11, 11, . . . are alternately provided so as to be separated in the extension direction of the concave groove section 7b.

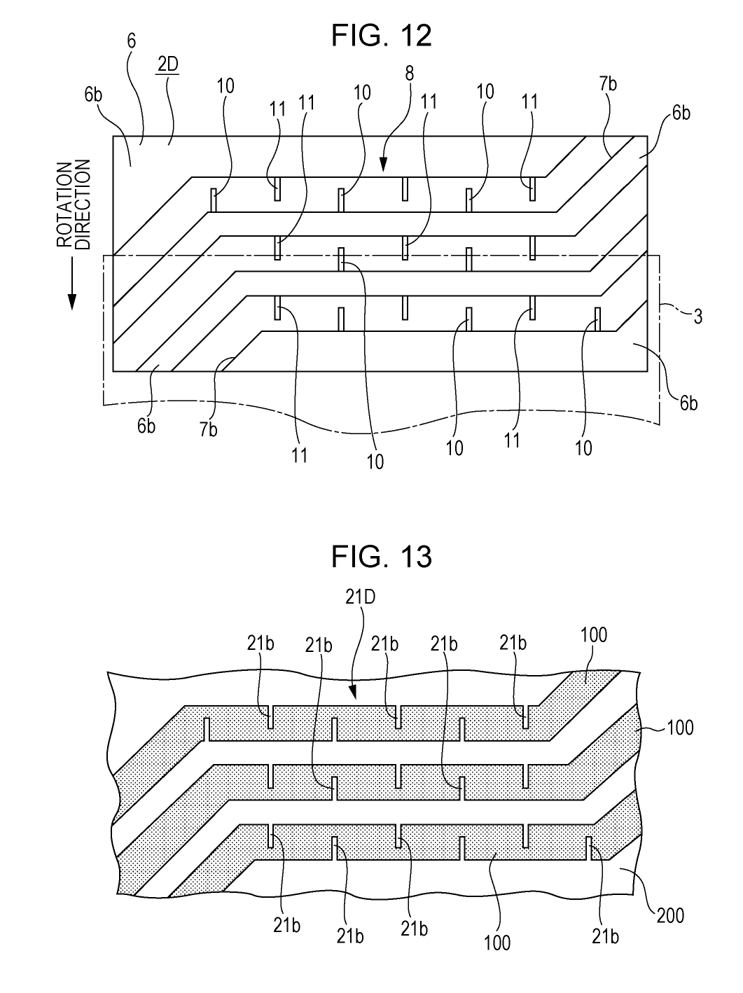

As described above, in the plate cylinder 2D, since the first walls 10, 10, . . . and the second walls 11, 11, . . . do not cross the concave groove section 7b, an intermediate pattern 21D is not interrupted due to the notch sections 21b, 21b, which are generated due to the first walls 10, 10, . . . and the second walls 11, 11, . . . as shown in FIG. 13. Accordingly, it is possible for conductivity to be secured in a state where the intermediate pattern 21D is formed and for a material with low fluidity to be used as the conductive ink 100 and it is possible to expand the selection options of the material which is used as the conductive ink 100. In addition, by using the conductive ink 100 with low fluidity, it is possible to reduce the width of the concave groove sections 7b, 7b, . . . of the printing pattern 8 and it is possible to reduce the size of the pattern plate 6 and the printing medium 200.

In addition, since the first walls 10, 10, . . . and the second walls 11, 11, . . . are alternately provided so as to be separated in the extension direction of the concave groove section 7b, each portion of the blade 3 in the extension direction of the front edge contacts at least one of the first walls 10, 10, . . . and the second walls 11, 11, . . . at the same time when the concave groove sections 7b, 7b, . . . are passed by the front edge of the blade 3 (refer to FIG. 12). That is, the blade 3 is necessarily in contact with either of the first walls 10, 10, . . . and the second walls 11, 11, . . . when the concave groove sections 7b, 7b, . . . are passed by the front edge of the blade 3. Accordingly, since it is difficult for the blade 3 to be inclined in the depth direction of the concave groove section 7b, it is possible to reliably regulate the infiltration of the blade 3 into the concave groove sections 7b, 7b, . . . using the first walls 10, 10, . . . and the second walls 11, 11, . . . .

Furthermore, since the first walls 10, 10, . . . and the second walls 11, 11, . . . are set to a length so as to overlap in the width direction of the concave groove section 7b, the blade 3 and the blanket roll 4 contact with at least one of the first walls 10, 10, . . . and the second walls 11, 11, . . . when the concave groove sections 7b, 7b, . . . are passed by the front edge of the blade 3 and the blanket roll 4. Accordingly, it is possible to more reliably regulate the infiltration of the blade 3 and the blanket roll 4 into the concave groove sections 7b, 7b, . . . using the first walls 10, 10, . . . and the second walls 11, 11, . . . .

In the description above, as the second modified example, the plate cylinder 2D is shown where the first walls 10, 10, . . . and the second walls 11, 11, . . . have a length so as to overlap in the width direction of the concave groove section 7b and are alternately provided so as to be separated in the extension direction of the concave groove section 7b. However, the walls may be provided in a state of not crossing the concave groove section 7b in the width direction of the concave groove section 7b, and it is possible for plate cylinders 2E, 2F, and 2G below to be configured as other examples of the second modified example.

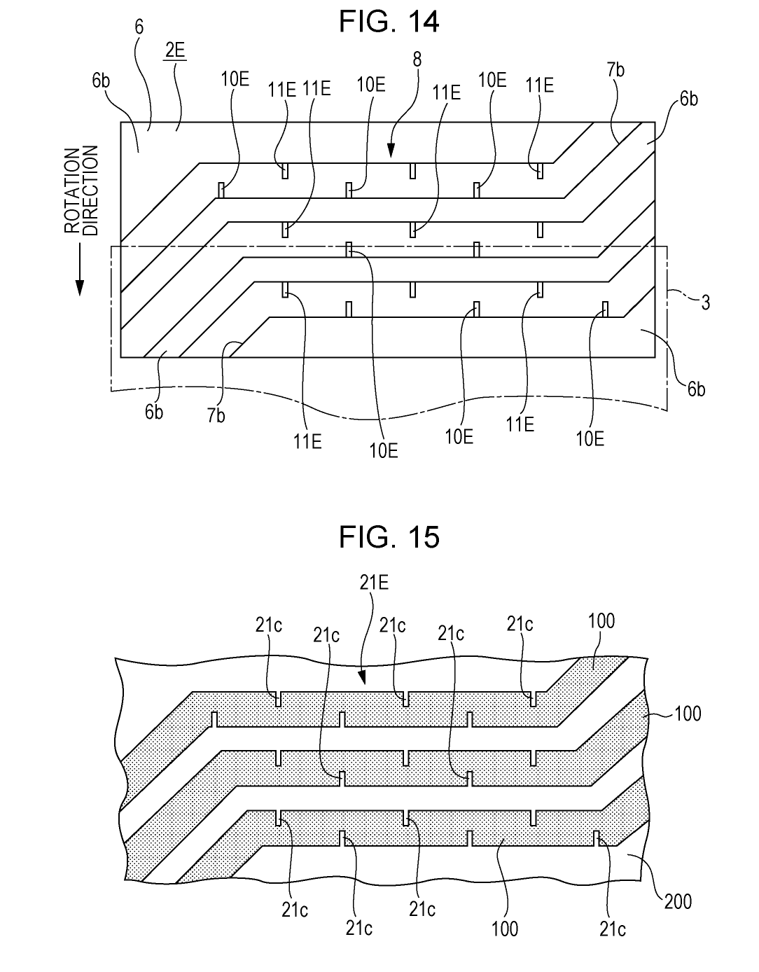

First walls 10E, 10E, . . . and second walls 11E, 11E, . . . are provided in the plate cylinder 2E (refer to FIG. 14). The walls 10E, 10E, . . . extend from the protrusion sections 6b of the pattern plate 6 in the width direction of the concave groove section 7b in a direction which is opposite to the rotation direction of the plate cylinder 2 and the front edge is, for example, positioned in the center in the width direction of the concave groove section 7b. The second walls 11E, 11E, . . . extend from the protrusion sections 6b of the pattern plate 6 in the rotation direction of the plate cylinder 2 and the front edge is, for example, positioned in the center in the width direction of the concave groove section 7b.

Here, in the description above, an example is shown where the front edge of the first wall 10E, 10E, . . . and the front edge of the second wall 11E, 11E, . . . are position in the center in the width direction of the concave groove section 7b, but the width of the first wall 10E, 10E, . . . and the second wall 11E, 11E, . . . may be half or less of the width of the concave groove section 7b as long as it is in the range where it is possible to regulate the infiltration of the blade 3 into the concave groove sections 7b, 7b, . . . using the first wall and the second wall.

As described above, in the plate cylinder 2E, since the width of the first wall 10E, 10E, . . . and the second wall 11E, 11E, . . . is half or less of the width of the concave groove section 7b, notch section 21c, 21c, . . . are small in the state where an intermediate pattern 21E is formed (refer to FIG. 15), and to that extent, excellent conductivity is secured in a state with low resistance. Accordingly, it is possible to secure excellent conductivity of a wiring pattern irrespective of the extent of the fluidity of the material which is used as the conductive ink 100.

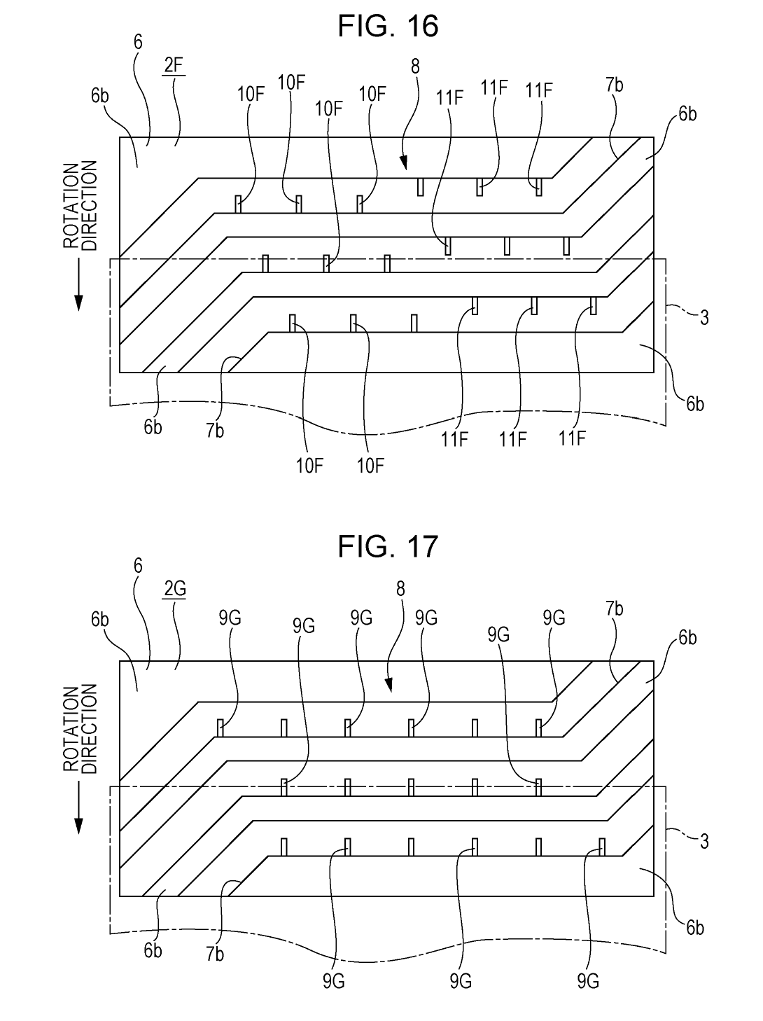

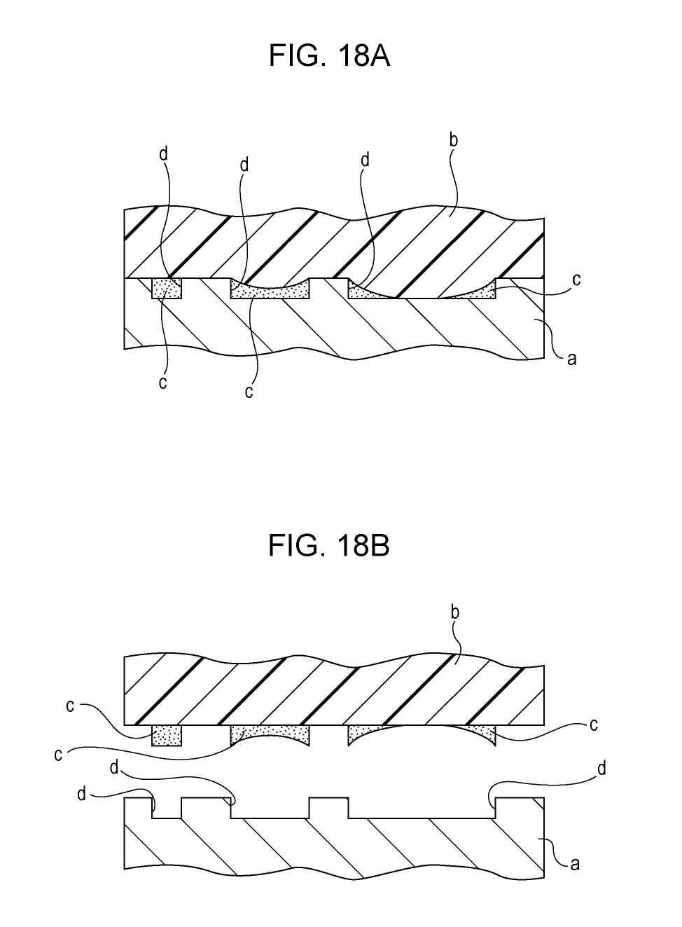

First walls 10F, 10F, . . . and second walls 11F, 11F, . . . are provided in the plate cylinder 2F (refer to FIG. 16). The first walls 10F, 10F, . . . are provided to be lined up so as to be separated in the extension direction of the concave groove section 7b and the second walls 11F, 11F, . . . are provided to be lined up so as to be separated in the extension direction of the concave groove section 7b. In addition, for example, the first walls 10F, 10F, . . . are disposed on one side in the extension direction of the concave groove section 7b and the second walls 11F, 11F, . . . are disposed on the other side in the extension direction of the concave groove section 7b.

Here, an example is shown where the first walls 10F, 10F, . . . and the second walls 11F, 11F, . . . are disposed by being divided into each side in the extension direction of the concave groove section 7b, but it is sufficient if the first walls 10F, 10F, . . . and the second walls 11F, 11F, . . . are disposed to be lined up so as to be separated in the extension direction of the concave groove section 7b, and the first walls 10F, 10F, . . . and the second walls 11F, 11F, . . . may be disposed in arbitrary positions in the extension direction of the concave groove section 7b.

Walls 9G, 9G, . . . are provided in the plate cylinder 2G (refer to FIG. 17). The walls 9G, 9G, . . . have one edge continuous with one opening edge on the rotation direction side of the plate cylinder 2 in the width direction of the concave groove sections 7b and the other edge separated from the other opening edge on the side which is opposite to the rotation direction of the plate cylinder 2 in the width direction of the concave groove sections 7b. For example, the other edge (front edge) of the walls 9G, 9G, . . . is positioned in the center in the width direction of the concave groove section 7b.

Here, an example is shown where the width of the walls 9G, 9G, . . . is half of the width of the concave groove section 7b, but it is possible to arbitrarily set the width as long as the walls 9G, 9G, . . . are continuous with one of the opening edges of the concave groove section 7b. In addition, one of the opening edges may be continuous with the edge which is opposite the concave groove section 7b.

As described above, even with the plate cylinders 2E, 2F, and 2G, the first walls 10E, 10E, . . . , the second walls 11E, 11E, . . . , the first walls 10F, 10F, . . . , the second walls 11F, 11F, . . . , and the walls 9G, 9G, . . . are provided in a state of not crossing the concave groove section 7b in the same manner as the plate cylinder 2D. Accordingly, it is possible to secure excellent conductivity in a state where the intermediate pattern is formed and to use the conductive ink 100 with low fluidity, and it is possible to expand the selection options of materials which are able to be used as the conductive ink 100.

### CONCLUSION

As described above, in the plate cylinders 2, 2A, 2B, 2C, 2D, 2E, 2F, and 2G, the walls 9, 9, . . . , the walls 9A, 9A, . . . , the walls 9B, 9B, . . . , the walls 9C, 9C, . . . , the first walls 10, 10, . . . , the second walls 11, 11, . . . , the first walls 10E, 10E, . . . , the second walls 11E, 11E, . . . , the first walls 10F, 10F, . . . , the second walls 11F, 11F, . . . , and the walls 9G, 9G, . . . are provided in the concave sections 7, 7, . . . which are formed in the pattern plate 6.

Accordingly, since the blade 3 contacts respectively with the walls 9, 9, . . . or the like when the conductive ink 100 which protrudes from the concave sections 7, 7, . . . of the pattern plate 6 is wiped away using the blade 3, it is possible to regulate the infiltration of the blade 3 into the concave sections 7, 7, . . . respectively using the walls 9, 9, . . . or the like and it is possible to reduce printing defects with regard to the printing medium 200.

Furthermore, the transfer section 4a contacts respectively with the walls 9, 9, . . . or the like when the conductive ink 100 which is filled into the concave sections 7, 7, . . . is transferred to the transfer section 4a of the blanket roll 4 and a portion of the transfer section 4a which respectively presses against the walls 9, 9, . . . or the like is not elastically deformed in the depth direction of the concave section 7. Accordingly, it is possible to regulate the infiltration of the transfer section 4a into the concave sections 7, 7, . . . respectively using the walls 9, 9, . . . or the like and it is possible to reduce printing defects with regard to the printing medium 200.

In addition, in the plate cylinder 2 and the like described above, the walls 9, 9, . . . or the like are respectively integrally formed using the same material as the portions of the pattern plate 6 other than the respective walls 9, 9, . . . or the like.

Accordingly, it is possible to reduce the number of processes when manufacturing the plate cylinder 2 or the like and it is possible to achieve a reduction in the manufacturing costs of the plate cylinder 2 or the like.

### [Present Disclosure]

Here, it is possible that the present disclosure has the configuration described below.

(1) A plate cylinder is provided with a base body with a cylindrical shape which is rotated in a predetermined direction and a pattern plate which is provided on an outer circumference surface of the base body and is rotated integrally with the base body and where a plurality of concave sections, which configures a predetermined printing pattern and is filled with conductive ink, is formed, where a blade, which wipes away the conductive ink which protrudes from the concave sections, contacts the outer circumference surface of the pattern plate, a blanket roll, to which the conductive ink is transferred and which performs printing by transferring the transferred conductive ink to a printing medium, contacts the outer circumference surface of the pattern plate, and a wall, which regulates infiltration of the blade and the blanket roll into the concave sections, is provided in the concave sections.

(2) The plate cylinder described in (1) where the concave sections are formed as a concave groove section where a portion is a groove shape and the wall extends in the width direction of the concave groove section.

(3) The plate cylinder described in (1) or (2) where the wall extends in a direction which is perpendicular to the rotation axis of the base body.

(4) The plate cylinder described in (2) or (3) where a plurality of the walls is provided in the extension direction of the concave groove section.

(5) The plate cylinder described in any one of (2) to (4) where both edges of the wall are each continuous with opening edges of the concave groove section on sides which are opposite in the width direction.

(6) The plate cylinder described in (4) where the wall has a first wall where one edge is continuous with one opening edge of the concave groove section in the width direction and the other edge is separated from the other opening edge of the concave groove section in the width direction and a second wall where one edge is continuous with the other opening edge of the concave groove section in the width direction and the other edge is separated from the one opening edge of the concave groove section in the width direction.

(7) The plate cylinder described in (6) where the first wall and the second wall are alternately provided by being separated in the extension direction of the concave groove section.

(8) The plate cylinder described in (7) where the first wall and the second wall are set to a length so as to overlap in the width direction of the concave groove section.

(9) The plate cylinder described in any one of (1) to (8) where the wall is integrally formed using the same material as a portion of the pattern plate other than the wall.

(10) A printing device is provided with a plate cylinder which has a base body with a cylindrical shape which is rotated in a predetermined direction and a pattern plate which is provided on an outer circumference surface of the base body and is rotated integrally with the base body and where a plurality of concave sections, which configures a predetermined printing pattern and is filled with conductive ink, is formed, a blade which contacts the outer circumference surface of the pattern plate and wipes away the conductive ink which protrudes from the concave sections, and a blanket roll which contacts the outer circumference surface of the pattern plate, to which the conductive ink is transferred, and which performs printing by transferring the transferred conductive ink to a printing medium, where a wall, which regulates infiltration of the blade and the blanket roll into the concave sections, is provided in the concave sections.

(11) The printing device described in (10) where the concave sections is formed as a concave groove section where a portion is a groove shape and the wall extends in the width direction of the concave groove section.

(12) The printing device described in (10) or (11) where the wall extends in a direction which is perpendicular to the rotation axis of the base body.

(13) The printing device described in (11) or (12) where a plurality of the walls is provided in the extension direction of the concave groove section.

(14) The printing device described in any one of (11) to (13) where both edges of the wall are each continuous with opening edges of the concave groove section on sides which are opposite in the width direction.

(15) The printing device described in (13) where the wall has a first wall where one edge is continuous with one opening edge of the concave groove section in the width direction and the other edge is separated from the other opening edge of the concave groove section in the width direction and a second wall where one edge is continuous with the other opening edge of the concave groove section in the width direction and the other edge is separated from the one opening edge of the concave groove section in the width direction.

(16) The printing device described in (15) where the first wall and the second wall are alternately provided by being separated in the extension direction of the concave groove section.

(17) The printing device described in (16) where the first wall and the second wall are set to a length so as to overlap in the width direction of the concave groove section.

(18) The printing device described in any one of (10) to (17) where the wall is integrally formed using the same material as a portion of the pattern plate other than the wall.

(19) A printing method includes filling conductive ink into concave sections of a plate cylinder which has a base body with a cylindrical shape which is rotated in a predetermined direction and a pattern plate which is provided on an outer circumference surface of the base body and is rotated integrally with the base body and where a plurality of the concave sections, which configures a predetermined printing pattern and is filled with conductive ink, is formed, wiping away the conductive ink which protrudes from the concave sections using a blade which contacts the outer circumference surface of the pattern plate, transferring the conductive ink which is filled into the concave sections to a blanket roll which contacts the outer circumference surface of the pattern plate and the wall, and performing printing by transferring the conductive ink which is transferred to the blanket roll to a printing medium.

The specific shapes and configuration of each section which is shown in the optimal embodiments shown above only show one specific example when realizing the present disclosure and is not to be interpreted as limiting the technical scope of the present disclosure.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A plate cylinder comprising:
a base body with a cylindrical shape which is rotated in a predetermined direction; and
a pattern plate which is provided on an outer circumference surface of the base body and is rotated integrally with the base body and where a plurality of concave sections, which configures a predetermined printing pattern and is filled with conductive ink, is formed,
wherein a blade, which wipes away the conductive ink which protrudes from the concave sections, contacts the outer circumference surface of the pattern plate,
a blanket roll, to which the conductive ink is transferred and which performs printing by transferring the transferred conductive ink to a printing medium, contacts the outer circumference surface of the pattern plate, and
a wall, which regulates infiltration of the blade and the blanket roll into the concave sections, is provided in the concave sections.

2. The plate cylinder according to claim 1,
wherein the concave sections are formed as a concave groove section where a portion is a groove shape, and
the wall extends in the width direction of the concave groove section.

3. The plate cylinder according to claim 1,
wherein the wall extends in a direction which is perpendicular to the rotation axis of the base body.

4. The plate cylinder according to claim 2,
wherein a plurality of the walls is provided in the extension direction of the concave groove section.

5. The plate cylinder according to claim 2,
wherein both edges of the wall are each continuous with opening edges of the concave groove section on sides which are opposite in the width direction.

6. The plate cylinder according to claim 4,
wherein the wall has a first wall where one edge is continuous with one opening edge of the concave groove section in the width direction and the other edge is separated from the other opening edge of the concave groove section in the width direction, and a second wall where one edge is continuous with the other opening edge of the concave groove section in the width direction and the other edge is separated from the one opening edge of the concave groove section in the width direction.

7. The plate cylinder according to claim 6,
wherein the first wall and the second wall are alternately provided by being separated in the extension direction of the concave groove section.

8. The plate cylinder according to claim 7,
wherein the first wall and the second wall are set to a length so as to overlap in the width direction of the concave groove section.

9. The plate cylinder according to claim 1,
wherein the wall is integrally formed using the same material as a portion of the pattern plate other than the wall.

10. A printing device comprising:
a plate cylinder which has a base body with a cylindrical shape which is rotated in a predetermined direction and a pattern plate which is provided on an outer circumference surface of the base body and is rotated integrally with the base body and where a plurality of concave sections, which configures a predetermined printing pattern and is filled with conductive ink, is formed;
a blade which contacts the outer circumference surface of the pattern plate and wipes away the conductive ink which protrudes from the concave sections; and
a blanket roll which contacts the outer circumference surface of the pattern plate, to which the conductive ink is transferred, and which performs printing by transferring the transferred conductive ink to a printing medium,
wherein a wall, which regulates infiltration of the blade and the blanket roll into the concave sections, is provided in the concave sections.

11. The printing device according to claim 10,
wherein the concave sections is formed as a concave groove section where a portion is a groove shape, and
the wall extends in the width direction of the concave groove section.

12. The printing device according to claim 10,
wherein the wall extends in a direction which is perpendicular to the rotation axis of the base body.

13. The printing device according to claim 11,
wherein a plurality of the walls is provided in the extension direction of the concave groove section.

14. The printing device according to claim 11,
wherein both edges of the wall are each continuous with opening edges of the concave groove section on sides which are opposite in the width direction.

15. The printing device according to claim 13,
wherein the wall has a first wall where one edge is continuous with one opening edge of the concave groove section in the width direction and the other edge is separated from the other opening edge of the concave groove section in the width direction, and a second wall where one edge is continuous with the other opening edge of the concave groove section in the width direction and the other edge is separated from the one opening edge of the concave groove section in the width direction.

16. The printing device according to claim 15,
wherein the first wall and the second wall are alternately provided by being separated in the extension direction of the concave groove section.

17. The printing device according to claim 16,
wherein the first wall and the second wall are set to a length so as to overlap in the width direction of the concave groove section.

18. The printing device according to claim 10,
wherein the wall is integrally formed using the same material as a portion of the pattern plate other than the wall.

19. A printing method comprising:
filling conductive ink into concave sections of a plate cylinder which has a base body with a cylindrical shape which is rotated in a predetermined direction and a pattern plate which is provided on an outer circumference surface of the base body and is rotated integrally with the base body and where a plurality of the concave sections, which configures a predetermined printing pattern, is formed and a wall is provided in the concave sections;
wiping away the conductive ink which protrudes from the concave sections using a blade which contacts the outer circumference surface of the pattern plate and the wall;
transferring the conductive ink which is filled into the concave sections to a blanket roll which contacts the outer circumference surface of the pattern plate and the wall; and
performing printing by transferring the conductive ink which is transferred to the blanket roll to a printing medium.
